(19) United States
(12) Patent Application Publication
(10) Pub. No.: US 2005/0021442 A1
(43) Pub. Date: Jan. 27, 2005

(54) Term-based concept instruments

(76) Inventors: Gary William Flake, Altadena, CA (US); David M. Pennock, Pasadena, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/625,001

(22) Filed: Jul. 22, 2003

(51) Int. Cl. G06F 17/60

(52) U.S. Cl. 705/37

(57) ABSTRACT

The present invention provides methods and systems for allowing transactions in instruments relating to term-based concepts in a networked computer system. Concepts may be defined as a set of terms, such as words or phrases, that relate to a theme. The terms are useable in computerized searches. The set of terms may be determined manually, using a computer algorithm, or both. Concepts are valued, such as by a measure of advertising value. Instruments include concept futures as well as bets. Concept-based instruments can be used, for example, as hedging tools, speculating tools, market forecasting tools, or data generating tools.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates in general to computerized trading systems, and in particular to methods and systems for allowing transactions in instruments relating to term-based concepts in a networked computer system.

With the growing popularity of networked computer systems including the Internet, use of computerized systems for facilitating transactions and trade are also gaining in popularity. In addition, Internet-based marketing, advertising, and sales continue to grow. Term-based search engines or search portals are used by consumer users to obtain search results relating to the users' topics of interest as expressed by search terms.

Search results can include, for example, a list of hits, each hit including a short description relating to a Web site as well a clickable or otherwise selectable link to a Web site. In this way, an Internet user can click through to a Web site where goods, services, or content of interest to the user may be found. Transactions may be conducted at the found Web site or a related Web site, such as the purchase or sale of goods, services or content, or trade. Search results may be provided based on various criteria, such as by being based on the presence of search terms in Web site addresses or content.

Terms used in computerized searches, and the topics, themes, or concepts to which the terms relate, can indicate important consumer interests and trends. Such trends and their future directions, as indicated by search terms, are naturally of interest to the public generally, and can also have a substantial impact on businesses economically, affecting advertising strategies and costs as well as the success and quantity of sales and other business activities, which are often associated with consumer interests and trends. Future consumer interests and trends can also be difficult to predict, leaving businesses with difficult to predict advertising costs, sales, etc. Businesses could benefit from a way to reduce the hardship caused by such unpredictability, or, where it is believed that a good prediction is available, to capitalize on it. In addition, businesses and the public alike have interest in predicting future consumer interests and trends, as indicated by search terms, whether for economic or advertising reasons, or for reasons relating to personal interest and the enjoyment of attempting to predict such things as what the next “hot” entertainer will be, what singer's current popularity will soon be on the downslide, what the next consumer electronics rage will be, etc.

Various computerized trading systems are known. U.S. Pat. No. 6,418,417 issued on Jul. 9, 2002 discusses a computer program for valuing weather-based financial instruments.

U.S. Pat. No. 6,038,554 issued on Mar. 14, 2000 discusses computer-assisted valuation of entities, using community surveys.

U.S. Pat. No. 6,505,174 issued on Jan. 7, 2003 discusses a computer-implemented trading system with a virtual specialist function.

Chan, N., E. Dahan, A. Lo and T. Poggio, “Experimental Markets for Product Concepts,” CBCL Paper No. 200/AI Memo No. 2001-013, Massachusetts Institute of Technology, Cambridge, Mass., July 2001 discusses market experiments in which participants express their preferences on new product concepts by trading in virtual securities, the value of concepts being determined by trader sentiment. A related article, Chan, Nicholas, Ely Dahan, Adlar Kim, Andrew Lo and Tomaso Poggio, “Securities Trading of Concepts,” Working Paper No. 172, 2002 discusses using pseudo-securities markets to measure preferences relating to new product concepts.

Iowa Electronic Markets, at Web site http://www.biz.uiowa.edu/iem/, discusses markets for instruments derived from political events and other markets.

As the above patents and publications demonstrate, while computerized systems are known for assisting in financial instrument trading and valuation, and market assessment, the existing art does not provide systems or methods for allowing transactions in instruments relating to term-based concepts.

There is a need in the art for systems and methods for allowing transactions in instruments relating to term-based concepts.

### SUMMARY OF THE INVENTION

In some embodiments, the present invention provides methods and systems for allowing transactions in instruments relating to term-based concepts in a networked computer system. Concepts may be defined as a set of one or more terms, such as words or phrases, that relate to a theme. The terms are useable in computerized searches. In some embodiments, the terms are obtained or derived from search terms used in computerized searches or terms from search engine systems. The set of terms may be determined manually, using a computer algorithm, or by a combination of both. Concepts are valued by a set of one or more parameters, such as by a measure of advertising value. Instruments include concept futures as well as bets. Concept-based instruments can be used, for example, as hedging tools, speculating tools, market forecasting tools, or data generating tools.

In one embodiment, the invention provides a method for allowing transactions in instruments. The method includes defining a set of one or more concepts, each of the concepts being capable of being valued based on a set of one or more parameters. The method further includes allowing transactions in a set of one or more instruments, each of the instruments being associated with one or more of the concepts, and each of the instruments being capable of being valued based on the value of the associated one or more concepts.

In another embodiment, the invention provides a method for allowing transactions in instruments on a networked computer system. The method includes defining a set of one or more concepts, each of the concepts being capable of being valued based on a set of one or more parameters. The method further includes, using the networked computer system, allowing transactions in a set of one or more instruments, each of the instruments being associated with one or more of the concepts, and each of the instruments being capable of being valued based on the value of the associated one or more concepts.

In another embodiment, the invention provides a method for allowing transactions in instruments on a networked computer system. The method includes defining a set of one or more term-based concepts, each of the concepts including a set of one or more terms, the terms being usable in computerized searches, and each of the concepts being capable of being valued based on a set of one or more parameters. The method further includes, using the networked computer system, allowing transactions in a set of one or more instruments, each of the instruments being associated with one or more of the concepts, and each of the instruments being capable of being valued based on the value of the associated one or more concepts.

In another embodiment, the invention provides a method for allowing transactions in instruments on a networked computer system. The method includes defining a set of one or more term-based concepts, each of the concepts including a set of one or more terms determined using one or more computer algorithms, the terms being usable in computerized searches, and each of the concepts being capable of being valued based on a set of one or more parameters for determining an advertising value of each of the concepts. The method further includes, using the networked computer system, allowing transactions in a set of one or more instruments, each of the instruments being associated with one or more of the concepts, and each of the instruments being capable of being valued based on the value of the associated one or more concepts.

In another embodiment, the invention provides a networked computer system allowing transactions in instruments. The system includes one or more client computers connectable to a network. The system further includes one or more server computers, connectable to the network, for facilitating transactions in instruments using the client computers, each of the instruments being associated with one or more concepts, each of the concepts including a set of one or more terms, the terms being usable in computerized searches, and each of the concepts being capable of being valued based on a set of one or more parameters.

In another embodiment, the invention provides a computer usable medium storing program code which, when executed on a computerized device, causes the computerized device to execute a method for defining a set of one or more concepts, each of the concepts including a set of one or more terms, the terms being usable in computerized searches, and each of the concepts being capable of being valued based on a set of one or more parameters. The method further includes, using the networked computer system, allowing transactions in a set of one or more instruments, each of the instruments being associated with one or more of the concepts, and each of the instruments being capable of being valued based on the value of the associated one or more concepts.

In another embodiment, the invention provides, in a computerized system for allowing transactions in instruments, the instruments being capable of being valued based on values of term-based concepts, and terms of the concepts being useable in computerized searches, a method for valuing a concept including a set of one or more terms. The method includes obtaining quantitative data associated with at least one of the concept and one or more of the terms of the term set. The method further includes operating on the data to produce a quantitative statistic. The method further includes determining a value of the concept based at least in part on the produced statistic.

In another embodiment, the invention provides, in a computerized system for allowing transactions in instruments, the instruments being capable of being valued based on values of term-based concepts, and terms of the concepts being useable in computerized searches, a method for valuing a concept including a set of one or more terms. The method includes obtaining quantitative data associated with at least one of demand for the concept and demand for one or more of the terms of the term set. The method further includes operating on the data to produce a quantitative statistic. The method further includes determining a value of the concept based at least in part on the produced statistic, comprising taking at least one measure to prevent intentional manipulation of the value of the concept.

In another embodiment, the invention provides, in a computerized system for allowing transactions in instruments, the instruments being capable of being valued based on values of term-based concepts, and terms of the concepts being useable in computerized searches, a method for determining a payoff on an instrument capable of being valued based on a value of a term-based concept. The method includes determining the value of the term-based concept at a first time. The method further includes determining the payoff based on the instrument and the determined value of the term-based concept.

In another embodiment, the invention provides, in a computerized system for allowing transactions in instruments, the instruments being capable of being valued based on values of term-based concepts, and terms of the concepts being useable in computerized searches, a method for determining a payoff on an instrument capable of being valued based on a value of a term-based concept. The method includes determining the value of the term-based concept over a first period of time. The method further includes determining the payoff based on the instrument and the determined value of the term-based concept over the first period of time.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a distributed computer system according to one embodiment of the invention;

FIG. 1A is a block diagram of a distributed computer system according to one embodiment of the invention;

FIG. 2 is a flow diagram depicting a method for transacting in instruments associated with term-based concepts, according to one embodiment of the invention;

FIG. 3 is a flow diagram depicting a method for transacting in instruments associated with term-based concepts, including determining search terms of a concept;

FIG. 4 is a flow diagram depicting a method for transacting in instruments associated with term-based concepts valued based on a measure of demand for the concept as a search-based advertising vehicle; and

FIG. 5 is a flow diagram depicting a method for transacting in instruments associated with term-based concepts, including betting.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In some embodiments, the present invention provides methods and systems for allowing transactions in instruments relating to term-based concepts in a networked computer system. Concepts may be defined as a set of terms, such as words or phrases, that relate to a theme. The terms are useable in computerized searches. The set of terms may be determined manually, using a computer algorithm, or by a combination of both. Concepts are valued by a set of one or more parameters, such as by a measure of advertising value. Instruments include concept futures as well as bets. Concept-based instruments can be used, for example, as hedging tools, speculating tools, market forecasting tools, or data generating tools.

In some embodiments, terms of concepts are useable as search terms, for example, in search engines and search portals accessible via the Internet. Such search engines or search portals can include non-sponsored search portals as well as sponsored or pay-per-click search portals or combination non-sponsored and sponsored portals. In some embodiments, terms of concepts are obtained or derived from terms used in computerized searches, or from terms obtained from search engine or search portal systems or servers, which can include databases of the systems or servers.

In the case of sponsored search portals, search results can be provided based on arrangements made be owners or operators of Web sites with the owner or operator of one or more search portals, or with an entity able to make arrangements with such search portals. For example, the owner of a Web site at which particular goods, services or content are sold might pay the search portal owner, or the another entity, to arrange for a hit, advertisement, or sponsored link relating to the Web site to appear among the search results for searches that include a term or terms that might indicate an interest in the offered goods, services, or content. In some embodiments, the search portal owner or operator, or other entity making such arrangements, is an owner or operator of, or is otherwise associated with, the market in concept-based instruments and any computer hardware or software used to facilitate transactions in the market, as described below.

In some instances, auctions are conducted in which Web site owners can bid on the position or prominence, or rank, of their advertisement or sponsored link in search results for a given search term or set of terms. In Pay-Per-Click or related types of arrangements, Web site owners who pay for an advertisement or link to their Web site to be featured in search results for a certain search term or terms may pay, for example, based on the number of users who click on their featured link.

Herein, the term “instrument” can include any vehicle, embodiment, or indicator of any interest, property, rights, privileges or benefits of any kind, including bets, and is not limited to formal written, documented or otherwise memorialized expressions, vehicles, embodiments or indicators. Herein the term “term” can include, for example, one or more characters, character strings, letters, words, phrases, abbreviations, sentences, or symbols of any kind. Herein, the term “concept” includes any group of one or more terms, but can, in some embodiments, include themes or abstractions that are not term-based. In some embodiments, a concept includes a group of terms that relate to a common theme. Herein, the term “concept market” includes markets that include concepts or instruments relating to concepts or terms of concepts.

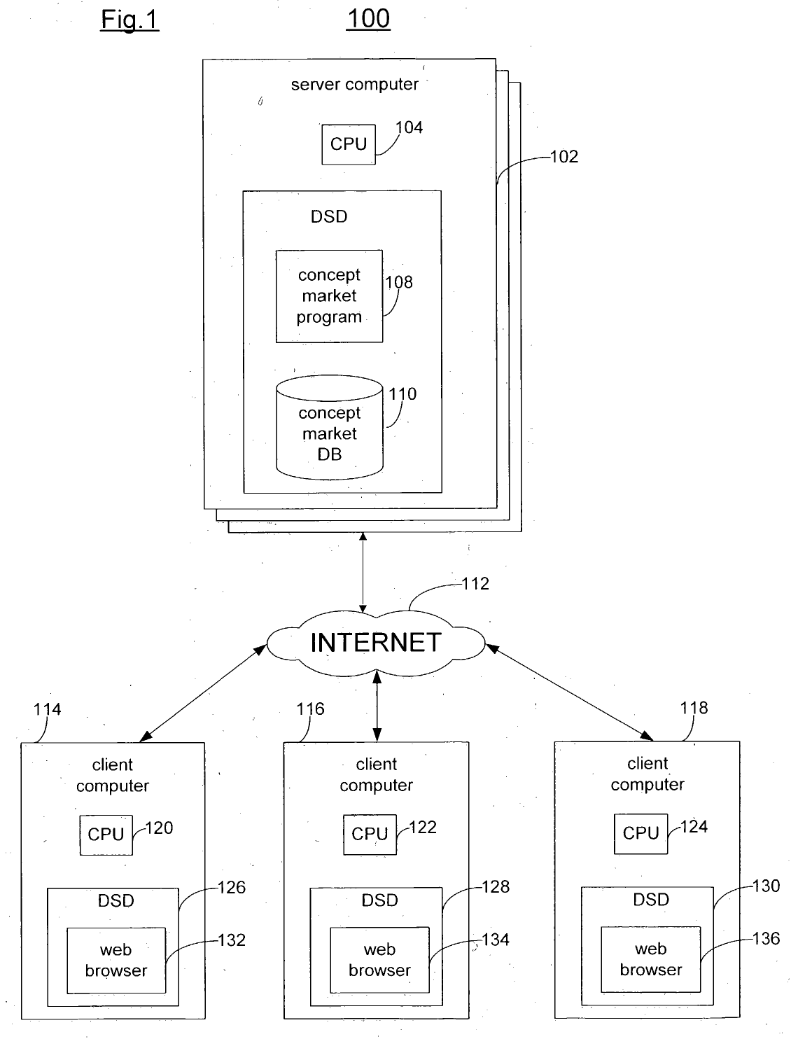

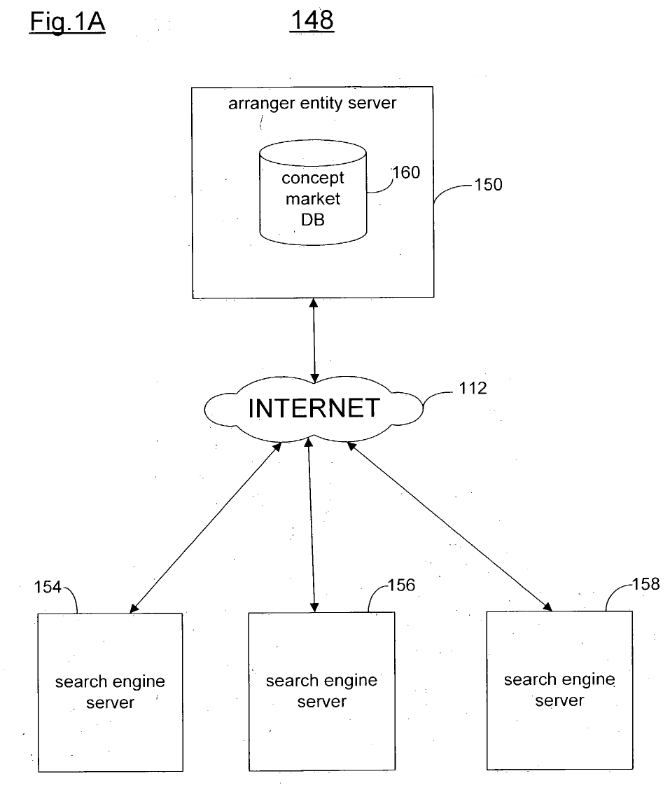

Herein, the term “market” includes any kind of trade, exchange, buying, selling, and transacting, as well as systems or entities that facilitate, accommodate or allow such activities. Electronic and computerized trading systems and markets are known in the art. Examples and descriptions relating to various computerized trading systems or elements thereof can be found, for example, in the following U.S. Patents, all of which are hereby incorporated herein by reference in their entirety: U.S. Pat. No. 6,505,174 to Keiser et al., U.S. Pat. No. 5,819,238 to Fernholz, U.S. Pat. No. 3,581,072 to Nymeyer, U.S. Pat. No. 5,101,353 to Lupien et al., U.S. Pat. No. 5,940,810 to Traub et al., U.S. Pat. No. 5,924,082 to Silverman, et al., U.S. Pat. No. 5,915,209 to Lawrence, U.S. Pat. No. 5,905,974 to Fraser et al., U.S. Pat. No. 5,873,071 to Ferstenberg et al., U.S. Pat. No. 5,819,237 to Garman, U.S. Pat. No. 5,809,483 to Broka et al., U.S. Pat. No. 5,774,880 to Ginsberg, U.S. Pat. No. 5,717,989 to Tozzoli et al., U.S. Pat. No. 5,497,317 to Hawkins et al., U.S. Pat. No. 5,454,104 to Steidlmayer et al., U.S. Pat. No. 5,297,032 to Trojan et al., U.S. Pat. No. 4,903,201 to Wagner, U.S. Pat. No. 4,774,663 to Musmanno et al., U.S. Pat. No. 4,674,044 to Kalmus et al., U.S. Pat. No. 5,313,560 to Maruoka et al., and U.S. Pat. No. 5,724,524 to Hunt et al. FIG. 1 is a block diagram of a distributed computer system 100 incorporating a concept market program 108, according to one embodiment of the invention.

In the computer system 100 depicted in FIG. 1, one or more server computers 102 is connected to one or more client computers 114, 116, 118 via the Internet 112. While the Internet 112 is depicted, the network connecting the computers can broadly include any of, or an array of, networks or distributed computer systems, which can include wired or wireless networks, public networks, private networks, secure or unsecured networks, cellular telephone networks, one or more local area networks, one or more wide area networks, peer-to-peer networks or systems, and may also include a connection to the Internet, although embodiments of the invention are contemplated in which no connection to the Internet is provided.

As described in detail below, the embodiments of the invention depicted in FIGS. 1 and 1A include a network of computers that can include one or more server computers, such as an arranger entity server including a concept market database and search engine servers, as well as client computers. It is to be understood, however, that embodiments of the invention are contemplated in which no network is included. For instance, in some embodiments, methods according to the invention are practiced using a computer, computerized device, or portable or handheld electronic or computerized device, unconnected to any network or other computer or device. For example, in some embodiments, methods according to the invention are practiced on a stand-alone computer or device using programming or information downloaded or otherwise obtained from one or more server computers or databases, or otherwise provided to, obtained by, or included with the computer or device.

Each of the client computers 114, 116, 118 comprises one or more Central Processing Units (CPUs) 120, 122, 124, and one or more data storage devices 126, 128, 130 which may include one or more network or Internet Browser programs 132, 134, 136.

The server computer 102 comprises one or more CPUs 104 and one or more data storage devices 106. The data storage device 106 comprises a concept market program 106 and one or more concept market databases 110, which can be a relational database or other type of database. While, as depicted, the concept market database 110 is located within the server computer 102, the invention contemplates embodiments in which the concept market database 110 is located completely or partially exterior to the server computer 102, and embodiments in which the concept market database 110 is distributed among multiple data stores and locations.

The data storage devices 106, 126, 128, 130 may comprise various amounts of RAM for storing computer programs and other data. In addition, both the server computer 102 and the client computers 114, 116, 118 may include other components typically found in computers, including one or more output devices such as monitors, other fixed or removable data storage devices such as hard disks, floppy disk drives and CD-ROM drives, and one or more input devices, such as keyboards, mouse pointing devices, or other pointing or selecting devices.

Generally, both the server computer 102 and the client computers 114, 116, 118 operate under and execute computer programs under the control of an operating system, such as Windows, Macintosh, UNIX, etc. In the embodiment shown, the invention is implemented using the concept market program 108 executed from the server computer 102, although in alternative embodiments the concept market program 108 could be located or executed elsewhere. The concept market program 106 broadly represents all programming, applications, software, or other tools used to facilitate implementing the methods of the invention as described herein.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

In various embodiments of the invention, users of the client computers 114, 116, 118 can transact in concept-based instruments with each other, or with a market, which can include one or more organizations, exchanges, books, gambling houses or organizations, or can transact with both. In some embodiments, the market can be associated with the server computer 102, the concept market database 110, or both. Access to the server computer 102, or a market provided by the server computer 102, can be public, or can be private or secure. In some embodiments, access is secured by one or more firewalls, password protection, or public, private key encryption, or by other means.

FIG. 1A is a distributed computer system 148 according to one embodiment of the invention. The system 150 includes an arranger entity computer 150 connected via the Internet 112, or some other network, to several search engine servers 154, 156, 158. The search engine servers 154, 156, 158 can be server computers associated with search engine or search portal owners or operators, and can provide search engines and search results to client computers that can be connected to the arranger entity server 150, the search engine servers 154, 156, 158, or both. The arranger entity computer can include the concept market program 108, as depicted in FIG. 1, and includes a concept market database 160, which can be one embodiment of the concept market database 110 as depicted in FIG. 1.

In some embodiments, an arranger entity, associated with the arranger entity server 150, makes arrangements in connection with search engine or portal servers or systems, such as for example, the search engine servers 154, 156, 158, or users thereof, and Web site owners or operators, or advertisers. For example, the arranger entity may facilitate providing sponsored links to Web sites or advertisements as part of search results provided to users of client computers that perform term-based computerized searches using a search engine provided by one or more of the search engine servers 154, 156, 158 (for more detail on some embodiments of systems including arranger entities, see the “Payoff Output” section herein). One example of an arranger entity is Overture Services, Inc., providing Internet-based computerized search-related services and arrangements. In some embodiments of the invention, search-related data, which can include search term and search term usage data and statistics, is communicated from the search engine servers 154, 156, 158 to be stored in the concept market database 160. In some embodiments, the search-related data can include, for instance, Pay-Per-Click auction data and statistics, as described in the “Concept Value Measurement” section herein.

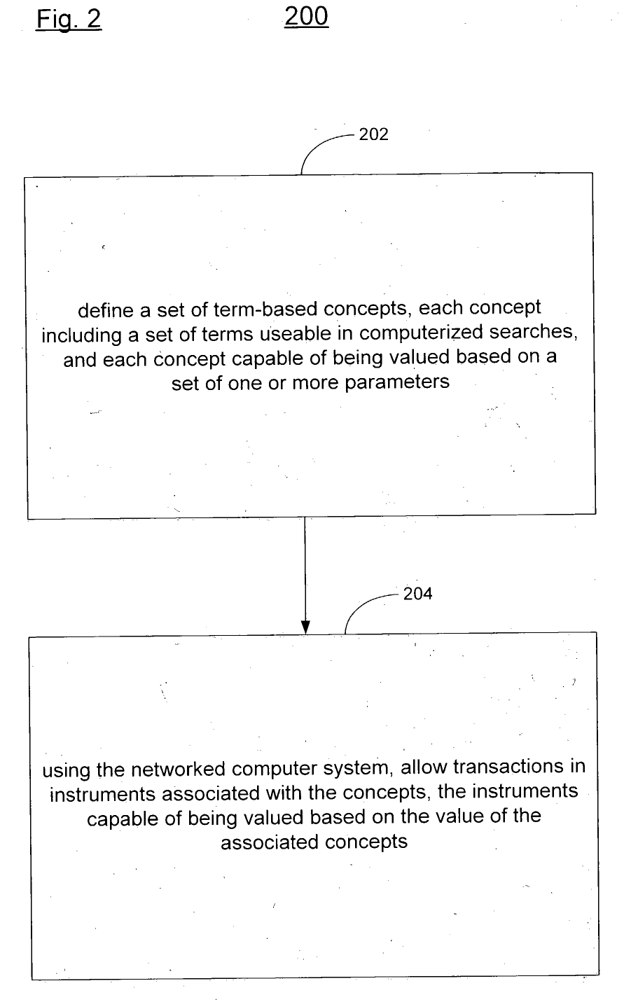

FIGS. 2-5 are flow charts that depict some embodiments of methods according to the invention. In some embodiments, the concept market program executed on the server computer 102 is used to allow trade, exchange, buying, selling, or otherwise transacting in instruments that are valued based on term-based concepts, by users of the client computers 114, 116, 118. For example, the server computer 102 may provide a Web page or Web pages accessible by the client computers, through which transactions are facilitated.

In some embodiments, a concept includes search terms that relate to a theme. For example, a concept named “Pocket PCs” may include terms that relate to handheld computing devices that use the Pocket PC format. The concept may include, for example, the terms “pocket,” “pocket PC” and “pocketPC.” Concepts can have difference possible breadths, or granularities with regard to specificity or generality. For example, a concept named “handheld computers” may be broader or more general than the Pocket PCs concept, and may include various search terms that relate to handheld computers of various sorts. For example, the handheld computers concept can include the above listed terms as well as terms such as “handheld computers,” “Windows CE,” and possibly many others.

The concepts can be valued in many different ways, based on various possible parameters. In some embodiments, the concepts are valued based on a measure or measures of their advertising or economic value or demand in connection with their use as search terms through some future period. For example, in a Pay-Per-Click context, the advertising value of a concept may depend on a measure of the popularity of the term or terms of the concept. For instance, if handheld computers become increasingly popular, the advertising value of the handheld computer concept may be greater, since more users will use the term in searches, potentially leading to more traffic, more clicks on sponsored links (the term “clicks,” as used herein, including any manner by which a link or other advertisement vehicle is selected or engaged), and more sales of goods, services, or content, for example, at the sponsored Web page or Web site.

Various possible techniques or approaches can be used in determining, calculating, or assessing computerized searches, search results, clicks, exposure to advertising, or their attributability to usage of particular concepts. Consider, for example, a case in which a concept is defined as including multiple terms. Usage of the concept could be defined or construed as requiring usage of any of the terms in a search, usage of some of the terms in a search, or can require usage of all of the terms of the concept in a search. Alternatively, a weighting system could be used in which a fractional usage measure is attributed to the concept based, for example, on the number of terms of the concept used in the search. Furthermore, consider a case in which a single search uses terms of two or more concepts. Usage could be assessed to be divided between the concepts, or could be assessed to be attributable to the concept including the first appearing search term, etc. In some embodiments, mathematical statistical formulae such as mean, median, etc., can be used in making such assessments and determinations.

FIG. 2 is a flow diagram depicting a method 200 for transacting in instruments associated with term-based concepts, according to one embodiment of the invention. The method 200 can be performed, for example, using the concept market program 108 and data from the concept market database 110. At step 202, a set of one or more term-based concepts are defined. Each of the concepts includes a set of terms useable in computerized searches, and each concept is capable of being valued based on a set of one or more parameters. At step 204, using the networked computer system 100, transactions are allowed in instruments associated with the concepts. The instruments are capable of being valued based on the value of the associated concepts.

As indicated in step 202, concepts are capable of being valued based on a set of one or more parameters. Such parameter or parameters include any kind of information, indicators, measures, statistics, descriptions, quantities, non-quantitative information, or other information used in valuing concepts, including, in some embodiments, information based on subjective human judgment or estimate.

Various types of values of concepts are contemplated by the invention. In some embodiments, the value of a concept can be determined by one or more indicators or measures, such as numerical or statistical indicators, of the economic or societal value, demand, or worth of the concept, or of component term or terms of the concept. Such indicators can be obtained, for example, from information provided by or associated with advertisers, businesses, organizations, consumers, or any combination thereof, as well as information pertaining to the activities the foregoing entities. The information can be explicit in indicating the value of the concept, or implicit in the sense that information from any of these entities may be useful in assessing the value of the concept even if the information does not specifically or exclusively indicate such value.

In some embodiments, the value of a concept is considered to be its present or future advertising value. In some embodiments, the advertising value can be determined by advertisers or advertising information. For example, the value of a concept can be measured by total quarterly revenue generated in Pay-Per-Click auctions, as discussed above, for all or some of the terms making up the concept. This measure may be appropriate since revenue generated from such auctions can be dependent upon amounts paid for such terms, and since advertisers will pay more for terms that are believed or assessed to have a greater advertising or economic value.

In some embodiments, the advertising value of the concept can be determined from purchasing or other consumer activities in connection with the concept. For example, for a concept associated with the singer Britney Spears, Pay-for-Performance (P4P) data associated with P4P consumer spending to hear Britney Spears' songs, or see and hear Britney Spears' music videos, can be used to determine advertising value.

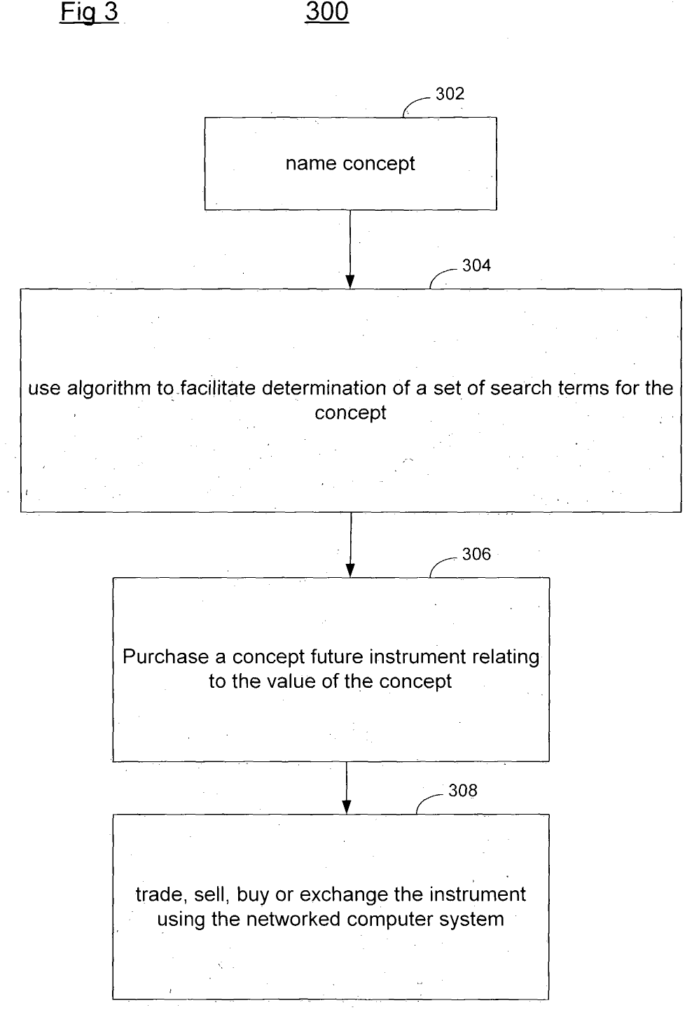

FIG. 3 is a flow diagram depicting a method 300 for transacting in instruments associated with term-based concepts, including determining search terms of a concept. The method 300 can be performed, for example, using the concept market program 108 and data from the concept market database 110. At step 302, a concept is named. In some embodiments, a concept is named according to the topic or theme to which the concept or its component terms relate.

At step 304 a computer algorithm is used to facilitate determination of a set of search terms for the concept. In some embodiments, the name of the concept is used making the determination, whereas in some embodiments it is not. In different embodiments, determination of the set of search terms can be performed manually, using one or more computer algorithms, or by a combination of both. For example, in some embodiments, search terms of a concept are determined by subjective, human judgment. In other embodiments, the search terms are determined using an algorithm such as a clustering, machine learning, or artificial intelligence algorithm or algorithms. Furthermore, in some embodiments, concepts or terms of concepts may be manually or automatically selected from a group of pre-determined concepts or terms. In addition, in some embodiments, terms of a concept may change or be revised over time, as pertinent factors change.

At step 306, a concept future instrument is purchased, the concept future instrument relating to the value of the concept. At step 308, the networked computer system is used to trade, sell, or exchange the instrument.

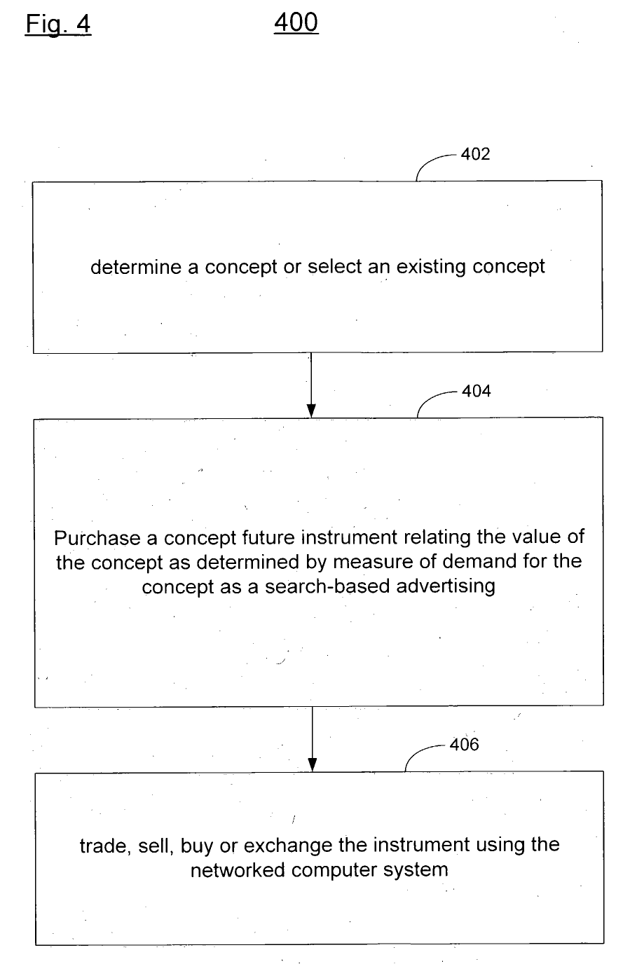

FIG. 4 is a flow diagram depicting a method 400 for transacting in instruments associated with term-based concepts valued based on a measure of demand for the concept as a search-based advertising vehicle, such as any measure of demand for use of a concept or its component term or terms in connection with advertising. The method 400 can be performed, for example, using the concept market program 108 and data from the concept market database 110. The measure, for example, may relate to demand for a term by Web site owners who bid for the term in a Pay-Per-Click auction. Such demand can be measured, for example, by statistics relating to an amount or amounts paid for listings in connection with search results from searches using the term.

At step 402, a concept is determined, or an existing concept is selected. At step 404, a concept future instrument relating to the value of the concept is purchased, the value of the concept being determined by a measure of demand for the concept as a search-based advertising vehicle, including demand for, use of, or any right or rights to the concept or one or more terms of the concept, relating to an advertising use or advertisement, and in connection with a search associated with the concept or one or more of its terms. At step 406, using the networked computer system, the instrument is traded, exchanged, bought, or sold.

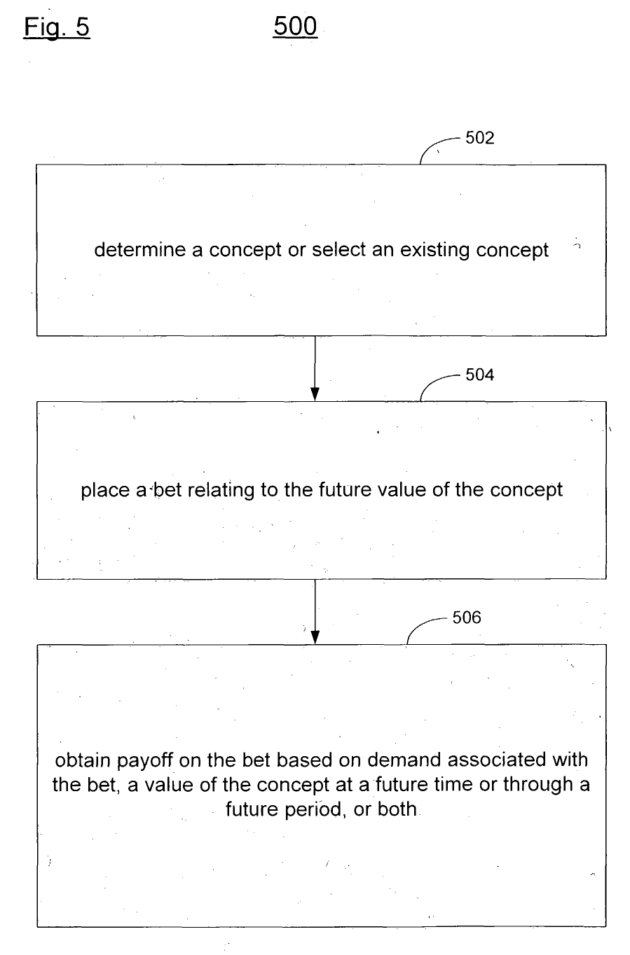

FIG. 5 is a flow diagram depicting a method 500 for transacting in instruments associated with term-based concepts, including betting. The method 500 can be performed, for example, using the concept market program 108 and data from the concept market database 110. At step 502, a concept is determined, or an existing concept is selected. At step 504 a bet is placed, made, or established, relating to a future value of the concept. At step 506, payoff is obtained on the bet. The payoff is based on demand associated with the bet, a value of the concept at a future time or through a future period, or both.

In some embodiments an entity offering a bet on a concept, such as a bet relating to a concept future, can set the price, payoff, or odds of the bet in whole or in part by or based on a measured demand or aggregate demand for the bet among entities such as bettors, the offering entity, or both. In some embodiments, the higher the aggregate demand associated with the placed bet, the higher the price of, or payoff for, the placed bet, and vice versa. In some embodiments, a price of the placed bet, payoff for placed bet, or both, can increase as aggregate demand associated with the placed bet increases. The aggregate demand can be, or can be assessed or measured by, for example, demand for, or a measure of demand for, identical bets, similar bets, or bets relating to the same concept or terms of the concept associated the placed bet. In some embodiments, bets whose payoff is inversely related to that of the placed bet have a negative effect on aggregate demand as pertains to the placed bet, which could be the case, for example, if the placed bet has a higher payoff if the associated concept increases in value, whereas another bet has a higher payoff if the concept decreases in value.

The invention contemplates a variety of types of instruments relating to concepts. As used herein, the term “payoff” includes anything obtained based on or in exchange for an instrument or instruments, including pay obtained for a stock or stock-like instrument, as well as payoff on a bet. Payoff can be in the form of money such as U.S. dollars, currency, fake money or currency, game money or currency, credits, coupons, discounts, certificates, items, goods, services, content, rights, rights to goods or services, rights to items, rights to goods or services at a specified price, options, or any other items or entities of tangible or intangible worth or value.

Generally, the payoff on an instrument is, or is related to, the value of the instrument at the time of the payoff. Herein, the term “concept future” includes any instrument, such as a betting instrument, financial instrument, or an instrument modeled after a betting instrument or financial instrument, the value or payoff of which is associated with a value of the concept over or for some future period, or at some future time. In some embodiments, a concept future has a present value that is a discounted future value. An example of a concept future is an instrument that pays quarterly dividends based on the quarterly revenue generated in Pay-Per-Click auctions for all or some of the terms of a particular concept, as discussed above.

In some embodiments, current prices for concept-based instruments, such as concept futures, fluctuate through time based on demand, just as the prices of stocks traded on public exchanges change based on demand. The price can go higher if demand increases, or lower if demand decreases.

In some embodiments, the server computer 102 is used to provide a marketplace, or virtual marketplace, accessible to the public, for example, via the Internet. The marketplace can be similar to or be modeled after, for example, a public stock market such as the New York Stock Exchange. At the virtual marketplace, orders can be placed and filled to buy, sell, trade, or exchange concept-based instruments such as concept-based stocks or virtual stocks. In some embodiments, orders are continuously filled using a standard double auction, or two-sided, auction mechanism.

In the following discussion, section headings are provided for general and overall organization purposes. Such headings do not indicate that text under such heading relates to or describes only aspects of the invention relating to the heading, nor indicate that description relating to a particular heading is found only under such heading.

### Concept Naming and Term Determination

As discussed briefly with reference to FIG. 3, choosing a concept, such as by naming and identifying terms of the concept, can be accomplished in many different ways. A concept name and terms can be generated manually by a person or team. Alternatively, the name or component terms can be chosen manually from a large corpus of names or terms generated by a manual or automatic process. As another alternative, the concept name and component terms can be chosen automatically from a large corpus of names and terms using a computational or computer algorithm or algorithms, such as a clustering algorithm, a machine learning algorithm, or an artificial intelligence algorithm or algorithms.

One way to generate or chose a concept or its component terms is to use some combination of automatic and manual means or methods. For example, the components can be generated automatically and the concept can be named manually. Alternatively, a computer algorithm can initially determine or select results which are then refined, changed, or added to manually, or a feedback loop can be employed involving multiple iterations of these steps.

Breadth or granularity of a concept was discussed briefly above in the general discussion relating to FIGS. 2-5. Generally, granularity describes how general or specific a concept is. In some embodiments, if concept components are chosen using a clustering algorithm, the algorithm can contain a parameter, or natural parameter, for setting the overall specificity or generality of the resulting clusters of terms. In some embodiments, the market, as provided, for example, by the server computer 102, is designed to include, or mainly include, very specific concepts, which at the extreme could consist of single terms, or, alternatively, of very general concepts, each consisting of many terms.

It is observed that certain factors are useful to consider in choosing or determining a concept or concepts. These factors include: (1) how understandable the concept is to market participants and the public; (2) how interesting the concept is to market participants or to the public; (3) how economically relevant the concept is with respect to hedging and forecasting (as described further herein); and (4) how difficult the concept name and terms are to generate and/or update over time, whether manually, automatically, or by a combination of both.

### Concept Value Measurement

Many different ways to gauge or determine the value of a concept are possible in various embodiments of the invention, including different measures, statistics, indexes, quantities, variables, and the like. Data for such measures can be stored, for example, in the concept market database 110 as depicted in FIG. 1.

Pay-Per-Click auctions have been briefly discussed above. The following are examples for gauging or determining the value of a concept using Pay-Per-Click auction information and statistics. “Revenue,” as used in the following discussion Pay-Per-Click auction-related examples, refers to revenue derived from the pay per click auction, such as by an entity that provides or facilitates the auction. In the following discussion, T represents a set of all terms making up a concept. tεT indexes a particular term. rₜ represents total revenue generated over a period of time (for example, one fiscal quarter) for a term t. bₜ is a list of bidded prices for term t over the period of time. Maxbidₜ=Max_{bεb}_{ₜ} b represents the maximum bidded price for a term t over the period of time. Similarly, Avgbidₜ=[sum_{bεb}_{ₜ} b]/[|bₜ|] represents the average bidded price, and medbidₜ=median _{bεb}_{ₜ}b represents the median bidded price. cₜ represents a list of clicked prices for a term t over the period of time, which can mean the list of prices actually paid by advertisers due to clicks (or other selection conduct). Maxclickₜ=Max _{cεc}_{ₜ}c represents the maximum clicked price for term t over the period of time. Similarly, avgclickₜ=[sum_{cεc}_{ₜ}c]/[|cₜ|] represents the average clicked price and medclick=median _{cεc}_{ₜ}c represents the median clicked price. cₐₗₗ represents the entire list of clicked prices for all terms tεT over the period of time.

Using the above, various possible measures for valuing a concept can be formulated, which can include operating on data, such as quantitative data relating to demand or popularity associated with the concept. The following are some such measures, which:
Total revenue per period: Σ_{tεT}rₜ (1)
Average revenue per period: [Σ_{tεT}rₜ]/[|T|] (2)
Median revenue per period: median _{tεT}rₜ (3)
Average of max bidded price: [Σ_{tεT}maxbidₜ]/[|T|] (4)
Average of median bidded price: [_{tεT}medbidₜ]/[|T|]
Median of median clicked price: median tεT medbidₜ (5)
Median click: median _{cεc}_{ₐₗₗ}c (6)

Endless variations of measures using the above or other formulations are possible. For example, in some embodiments, it may be preferable or more natural to compute max, mean, and median bidded and clicked prices over shorter time periods than the life of a concept future, such as, for example, over hours or days rather than over fiscal quarters. In such a case, aggregation could be performed over the life of the concept future, for example, over the fiscal quarter, using mean, median, etc. Other possible measures can focus on capturing or more effectively capturing popularity of a concept among the general public, rather than reflecting economic value to advertisers and businesses. In some embodiments, for example, value can be subjectively manually determined.

It is observed that certain factors are useful to consider in choosing or determining a measure of value of a concept or concepts. These factors include: (1) how understandable the statistic is to market participants or the public; (2) how interesting the statistic is to market participants or the public; (3) how economically relevant the statistic is for hedging and forecasting (as described further herein); (4) the availability of relevant data; (5) how much proprietary information is revealed by releasing the value of the statistic; and (6) how resistant the statistic is to intentional manipulation. Intentional manipulation can include, for example, attempts to cause untrue, inaccurate, unfair, deceptive, or unreasonable valuation of a concept, concepts, a term, or terms.

It is observed that median click in some circumstances may offer a good tradeoff or compromise among the listed factors. In particular, median click is reasonably easy to understand, should be correlated with hedging and forecasting concerns, can be easy to compute, does not generally reveal too much internal information, and can be more resistant to manipulation than the average or maximum operators.

In some embodiments of the invention, in order to reduce effects of intentional manipulation, some number of highest and lowest figures is dropped when computing averages, means, median click, etc. In some embodiments, manipulation is monitored, actively or passively, by, for example, analyzing trading patterns, comparing IP addresses or cookies between ad clicks and trading accounts, or by other techniques.

### Payoff Mechanism

Payoff on a concept-based instrument, such as a concept future, is discussed briefly above with reference to FIG. 5. A payoff mechanism or payoff function can be used to define how realized values of the statistic are translated or used to translate into payoffs to concept instrument owners. Various forms of payoff mechanisms are possible. Two such mechanisms are linear payoff and binary payoff. In a linear payoff mechanism, each concept instrument can pay off an amount linearly proportional to the realized value of the statistic. In a binary payoff mechanism, each concept can pay off a fixed amount, for example, one dollar or other unit of any type of value, if and only if the realized value for the statistic satisfied some prespecified Boolean function of the statistic, for example, by being above some threshold.

In some embodiments, the payoff mechanism is based on or modeled after a financial or betting instrument, such as a traditional such instrument. This may aid understanding or spark additional interest among market participants, the public, the media, or businesses. For example, payoff mechanisms relating to concept-based instruments can be defined in analogy to either financial securities or bets, as described further as follows.

In some embodiments, payoff mechanisms are defined as or in analogy to financial securities such as, for example, stocks, options, futures, and derivatives. For concept-based instruments that are, are modeled after, or are analogous to stocks (hereinafter called concept-based stocks), stock-based payoff techniques can be used, which can take the form, for example, of dividends paid periodically, such as quarterly, in proportion to a realized value of a statistic or value measure.

For concept-based instruments that are, are modeled after, or are analogous to options (hereinafter called concept-based options) option-based payoff techniques can be used, which can take the form max (0, s−k) (concept-based call options) or max (0, k−s) (concept-based put options), where s is a realized value of a statistic or measure and k is some prespecified strike value. In a Pay-Per-Click setting, as discussed above, concept-based call or put options can, for example, be defined as a right to buy or sell clicks at a certain strike price at some future time, the right to buy or sell clicks at a certain rank at a certain future time, or a right to buy or sell impressions at a certain rank at a certain time.

For concept-based instruments that are, are modeled after, or are analogous to futures (herein called concept futures), futures-based payoff techniques can be used, which can take the form, for example, in a Pay-Per-Click setting, of clicks, a right to a certain number of clicks, market value of a certain number of clicks at time of realization, a right to a certain number of impressions, a right to a certain number of clicks or impressions at a certain rank or at a certain affiliate, site or venue, or variations on or combinations of any of the foregoing.

Concept-based instruments can also be, be modeled after, or be analogous to, bets (herein called concept-based bets), such as, for example, odds bets, line bets, and parimutuel bets. For concept-based odds bets, betting-based payoff techniques can be used, in which payoffs can be in proportion to going, or current, odds assigned to each of two or more discrete outcomes of a statistic or value measure. Odds can be determined based on demand of participants to wager on various outcomes or beliefs of the market institution or market-providing or operating entity.

Concept-based line bets can have payoffs that are, for example, equal for each of two discrete outcomes of a modified statistic or value measure, where the modification, such as an addition to or subtraction from, is according to a going line or spread, the line or spread being determined based on demand of participants to wager on either outcome and/or beliefs of the market institution or market-providing or operating entity.

Concept-based parimutuel bets can have payoffs that are, for example, inversely proportional to a total amount bet on each of two or more discrete outcomes of a statistic or value measure. As one alternative, a total amount bet on all outcomes, minus a fee, can be split among those who bet on the winning outcome, in proportion to the amounts of their bets.

### Payoff Output

While a payoff mechanism can determine quantity of payoff, the payoff, or payoff output, includes any currency or form of payoff or in which payoff is made. Payoff output can be in any number of forms, as discussed above, including real money, fake money, discounts, rights to clicks, or any items of tangible or intangible value.

In some embodiments of the invention, payoff is made in real money, but, in some embodiments, the market is run as a game or partly as a game, and payoffs can take, or partly take, other forms, including fake or game money. In game embodiments, incentives to play (participate) and reveal information can come at least in part from players desire for fun, competitive spirit, will to win, desire for bragging rights, desire for recognition, etc. In some embodiments, game money can be cashed in for prizes, credits to be used for transactions in the market or for other things of value, credits that can be used in other markets or exchanges, such as online Internet trading sites, credits that can be used for purchases from one or more search portal owners or operators offering Pay-Per-Click or related arrangements or auctions, credits that can be used for purchases from another entity that arranges or facilitates arrangements with the one or more search portal owners or operators in connection with Pay-Per-Click or related arrangements or auctions, etc. In some embodiments, concept-based instrument market games can be designed to transition into real money markets at some future time.

With regard to entities that own, operate, or are otherwise associated with Pay-Per Click or related auctions as well as a market in concept-based instruments, such as instruments whose value is based on concepts or terms of concepts that are subjects of the auction, participants in the market for concept-based instruments can be awarded game money based on an amount that they spend in related Pay-Per-Click auctions. In some embodiments, with regard to payoffs in credits, credits can be in the form of such things as coupons, discounts, or certificates that can be used in connection with, for example, the entity that is associated with the Pay-Per-Click auctions, search portals associated with the market, or one or more arranger entities that make arrangements with such search portals in connection with the Pay-Per-Click or related auctions. Credits can be in the form, for example, of absolute cash equivalents or percent discounts. Payoff in credits can be accomplished indirectly by defining payoffs in terms of fake or game money, then allowing credits to be purchased using the fake or game money.

As mentioned above, payoff output can also relate to rights for clicks or impressions. For example, payoffs can be made in the form of rights to clicks or impressions, rights to clicks or impressions at certain affiliates, sites, or venues, rights to clicks or impressions at a certain rank over a certain period of time, or other variations. Rewards can be defined if owed or promised clicks or impressions are not delivered. Listings for entities that have won rights to clicks or impressions may need to be carefully integrated with listed of merchants bidding in a spot market for placement.

Due to differing laws in different countries, different types or versions of a concept-based instrument market can be run in different countries. For example, a game market could be run in the U.S. while a real money betting concept-based market could be run in the U.K.

### Participants

Participation in concept-based markets can be open to the public or restricted in some way. For example, if payoffs are in credits useable for purchases at one or more business entities, participation can be limited to customers of those business entities. For instance, if the concept-based market operator is also an arranger entity, credits may be useable only by users or merchants of the arranger entity. Restrictions can also take the form of, for example, blocking participation from countries in which the concept-based market being run is legally restricted.

### Audience

In some embodiments, a concept-based market generates various price information, which can be stored, for example, in the concept market database, as described with reference to FIG. 1. A market audience can be defined as those who are able to access this price information. The market audience can include participants in the market only, or can be larger, to include, for example, all entities, such as merchants, who are customers, clients, or subscribers of an entity that owns or operates the market, such as the arranger entity, or paying customers, clients, or subscribers only. The audience can also include all partners of the arranger entity, such as, for example, search portal owners or operators. The audience can also include specific media outlets or the public at large.

### Descriptive Terminology

Various terminologies can be used in connection with concept-based markets and payoffs. Choice of such terminology can be important due to impacting understandability among participants, the public, and the media. Additionally, terminology can potentially impact interest by or consequences associated with regulatory bodies and legal institutions. In some embodiments, the terminologies used include, in the financial security area, derivatives, stocks, options, and futures; in the gambling area, terminologies include familiar gambling terminologies such as odds, lines, bets, spreads, etc.

In some embodiments, a concept-based market is set up and described as a mechanism for choosing among alternative payment plans, in a manner that can be analogous to cell phone plans that allow subscribers to choose to increase their upfront flat payment to reduce their future per-minute costs. For example, subscribers or merchants of an arranger entity who purchase concept-based instruments as well as concept rights, such as search result listing, advertisment, or link rights, relating to the same, or possibly a related, concept, can be viewed and described as altering their payment plan with regard to the arranger entity by purchasing the instrument. For example, the sum due to the arranger entity can include the arrangement cost as offset (or increased, as the case may be) by the purchase and eventual payoff on the related concept-based instrument. Similarly, participants can also view as a form of insurance the purchase of concept-based instruments whose payoff is, or is likely to be, proportional to the eventual sum due to the arranger entity based on a quantity of clicks in a Pay-Per-Click arrangement, so that, for example, the more clicks, the more money due to the arranger entity, but the more the payoff on the instrument, and vice-versa.

### Independence

A concept-based market can be fully owned by, partially owned by, or independent from an entity that generates data on which the concept value measure or statistic is based. Furthermore, the measure may be based on data from a single entity, company, or source, or may be aggregated from multiple independent sources.

In some embodiments, opportunities are provided for different levels or types of participation in a concept-based market. For example, there can be a class of traders called institutional traders that pay for a privilege of having greater access to trade or price data that may be stored in the concept market database 110 as depicted in FIG. 1, for example, such as for market research purposes, or pay for other privileges not given to other participants. Furthermore, there can be exchange members or affiliates that are allowed to structure derivatives or mutual funds, which functions would otherwise be reserved for an owner of the market. In some instances, allowing institutional participation or other levels of participation can increase revenue, allow for a more liquid market, better leverage trading or price data, or introduce new means for affiliate participation.

### Uses

There are many types of possible uses for concept-based instruments. These uses include use as a hedging tool, a speculating tool, a forecasting tool, a data generating tool, or an entertainment tool.

Hedging can be important as a tool for nearly all businesses. It can be difficult or impossible, however, to hedge against changes in trends, tastes, popularity, ideas, or technologies, even though these are some of the most volatile variables in business. For example, within industries of entertainment, such as music, movies, television, fashion, toys, consumer electronics, computers, advertising, and others, large swings in trends are common and exert powerful forces. By the use of a concept-based instrument market, participants can hedge against future changes in the value of concepts. For example, a business that is concerned that advertising costs will rise for a particular concept can buy the corresponding concept future, thereby effectively purchasing insurance against future price increases. If advertising prices do increase, for example in a Pay-Per-Click setting, the business will pay more to compete for placement, but will be compensated with gains in its concept future investment. More generally, a business whose revenue is tied to the value of a particular concept can hedge against downturns in the value of the concept.

Participants in a concept-based market can also use concept-based instruments as a speculating tool by literally or effectively placing bets on the future direction of value of concepts. Participants who feel that they can effectively predict which concepts will rise or fall in value can earn an expected profit by trading in the concept futures market.

Concept-based instruments can also be used as a forecasting tool. Much evidence demonstrates that prices in financial markets and betting markets, even when they are run with play money, constitute accurate forecasts. Prices of concept-based instruments would provide forecasts of future values of concepts. Concept futures, for instance, can be used to predict answers to such questions as, what toys will be hot next Christmas? What new car model will flop in the coming months? Which celebrity's popularity will soon dwindle? Which gadgets just announced at the Consumer Electronics Show will fly off the shelves? A concept futures market, for instance, can help answer such questions.

A concept-based market can be used as a data generating tool, potentially providing data, including not only price data, but a wealth of specific and potentially proprietary data, which data could be saved, for example in the concept market database as depicted in FIG. 1. For example, very valuable demographic cross-section information could be obtained, answering or helping to answer questions such as, what are young male sports fans buying or selling? What age group is buying minivan-related concepts? What region of the country is leading trends, and what region is following? What pairs of concepts have a strong overlap of traders in common? Such information, along with other non-public information such as volume, timing, IP address information, participant information, etc., could be re-packaged and sold as a potentially very valuable and unique form of market research.

Many participant traders will likely be motivated simply by the challenge and enjoyment of trying one's hand at predicting the future value of concepts. Interest in a concept-based instrument market can drive or draw attention from traffic, merchants, affiliates of arranger entities, etc.

### Revenue

Various forms and sources of revenue can be available to an owner or operator of a concept-based market, such as an arranger entity or other entity. If payoff output is in real money, an important or main source of revenue is likely to be transaction fees, which can be charged by the owner or operator of the market, similar, for example, to other major financial or betting markets.

Listing fees can also be a source of revenue, especially after a market is well-established. For example, listing fees can be charged to place a particular concept on the market. For instance, a car company may be willing to pay a fee in order to list its latest model, or to list one of its concept cars, in order to gauge its value or popularity.

Fees for institutional participation and exchange member participation (as described above) can also be charged for greater data access or other services or privileges in connection with the market.

Data selling or re-selling can be another source of revenue, including data on patterns, demographic trends, etc., in connection with the market, which data can be at least initially saved, for example, in the concept market database 110 as depicted in FIG. 1. In some embodiments data mining techniques, programs, or software programs, for example, can be used in order to help obtain, organize, or collect such data.

Furthermore, revenue can be generated as a result of the traffic, publicity, and interest surrounding the market, which can help attract merchants, clients, customers, subscribers, etc. to Web sites, for instance of market owners or operators, such as arranger entities.

### Example Implementation Parameters

In some embodiments of the invention, an implementation includes the following attributes. Concept determination or definition can be performed using a combination of automatic clustering and manual inspection or tweaking. Median click or total revenue can be used as a concept value measure or statistic. Payoff mechanism can be according to a stock analogy. Payoff output can be in game currency, with the market system having the ability to move to allowing purchase of credits or prizes with the game currency. Participation can be open to the public, and audience can be public. Descriptive terminology can include financial securities and stock terminologies. The market can be wholly owned by an arranger entity. Institutional participation can be initially not allowed, but the market system can have the ability to move to allowing institutional participation.

In some embodiments of the invention, another implementation includes the following attributes. This implementation may be of particular use in the U.S. Concept determination or definition can be performed using a combination of automatic clustering and manual inspection or tweaking. Median click or total revenue can be used as a concept value measure or statistic. Payoff mechanism can be according to a stock analogy. Payoff output can be in real money. Participation can be open to the public, and audience can be public. Descriptive terminology can include financial securities and stock terminologies. The market can be minority owned by an arranger entity or independent from any arranger entity. Institutional participation can be allowed.

In some embodiments of the invention, another implementation includes the following attributes. This implementation may be of particular use in the U.K. Concept determination or definition can be performed using a combination of automatic clustering and manual inspection or tweaking. Median click or total revenue can be used as a concept value measure or statistic. Payoff mechanism can be according to a gambling analogy. Payoff output can be in real money. Participation can be open to the public, and audience can be public. Descriptive terminology can include gambling terminologies. The market can be minority owned by an arranger entity or independent from any arranger entity.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. In a computerized system for allowing transactions in instruments, the instruments being capable of being valued based on values of term-based concepts, and terms of the concepts being useable in computerized searches, a method for determining a payoff on an instrument capable of being valued based on a value of a term-based concept, the method comprising:
determining the value of the term-based concept at a first time; and
determining the payoff based on the instrument and the determined value of the term-based concept.

2. The method of claim 1, comprising determining thepayoff using a linear payoff technique.

3. The method of claim 1, comprising determining the payoff using a binary payoff technique.

4. The method of claim 1, comprising determining the payoff using a stock-based payoff technique.

5. The method of claim 1, comprising determining the payoff using an options-based pay-off technique.

6. The method of claim 1, comprising using a futures-based payoff technique in determining the payoff.

7. The method of claim 1, comprising using a betting-based payoff technique in determining the payoff.

8. The method of claim 1, comprising denominating the payoff in at least one of real currency, fake currency, game currency, coupons, discounts, certificates, and rights.

9. The method of claim 1, comprising determining the payoff in rights relating to advertising.

10. The method of claim 1, comprising determining the payoff at least one of rights to clicks and rights to impressions.

11. The method of claim 1, comprising using the instrument as at least one of a hedging tool, a speculating tool, a forecasting tool, a data generating tool, and an entertainment tool.

12. The method of claim 1, wherein an entity that at least in part facilitates allowing of transactions capable of being valued based on values of term-based concepts also at least in part facilitates Pay-Per-Click auctions for rights associated with the concepts, and comprising the entity deriving revenue from at least one of transaction fees, listing fees, institutional participation fees, data sale, and publicity.

13. In a computerized system for allowing transactions in instruments, the instruments being capable of being valued based on values of term-based concepts, and terms of the concepts being useable in computerized searches, a method for determining a payoff on an instrument capable of being valued based on a value of a term-based concept, the method comprising:
determining the value of the term-based concept over a first period of time; and
determining the payoff based on the instrument and the determined value of the term-based concept over the first period of time.
